(19) United States
(12) Patent Application Publication
(10) Pub. No.: US 2026/0192946 A1
(43) Pub. Date: Jul. 9, 2026

(54) MANUALLY INSERTABLE KEY EXTENDER

(71) Applicant: Government of the United States as represented by the Secretary of the Air Force, Wright-Patterson AFB, OH (US)

(72) Inventors: Michael Williamson, Peoria, AZ (US); Tabitha Au, Luke AFB, AZ (US)

(21) Appl. No.: 19/010,494

(22) Filed: Jan. 6, 2025

(51) Int. Cl. B64F 5/50

(52) U.S. Cl. CPC B64F 5/50

(57) ABSTRACT

A tool for aligning the nose landing gear tire of an F-35 aircraft. The F-35 landing gear has a fixed forward notch which is used to align the landing gear and tire with the centerline of the airframe. The tool has a key which can be inserted into and retracted from the notch. Torque may then be applied to key to adjust the azimuthal angle of the landing gear. The key is joined to an extender, which, in turn is joined to a yoke. The yoke may be removably joined to the landing gear to index the key to the notch.

### STATEMENT OF GOVERNMENT INTEREST

The invention described and claimed herein may be manufactured, licensed and used by and for the Government of the United States of America for all government purposes without the payment of any royalty.

### CROSS REFERENCE TO RELATED APPLICATION

This application claims the benefit of and priority to pending U.S. application Ser. No. 18/731,797 filed Jun. 3, 2024, the disclosure of which is incorporated herein by reference.

### FIELD OF THE INVENTION

The present invention is related to a tire alignment tool for the nose landing gear of an F-35 aircraft, and particularly to such a tool which has a bilaterally extendable and retractable key for aligning the azimuth of the landing gear.

### BACKGROUND OF THE INVENTION

The Lockheed Martin F-35 is a single seat stealth-capable aircraft capable of carrying an ordinance payload greater than 8100 kg at supersonic speeds. The F-35 is said to be the most advanced aircraft in the world and expected to replace a host of other fighter aircraft, both domestically and internationally. Production of the F-35 airframe began Nov. 10, 2003 with the first flight completed Dec. 15, 2006.The F-35 airframe is executed in three platforms: the F-35A Lightening Il designed for conventional runways and the most common platform; the F-35B Lightening II with vertical landing and short-field takeoff capability and the F-35C Lightening Il built for aircraft carrier operations. All three platforms have one nose and two aft landing gear/wheel combinations.

Nine countries were involved with the development of the F-35 airframe. More than 1500 companies and 250000 jobs are involved in the supply chain and production of the F-35 airframe. Despite all of these advanced capabilities across three platforms, numerous development partners, years of production and thousands of hours of flight time, problems remain.

For example, F-35 tires are reported to last for 10 or fewer landings. It takes a four-man crew to lift an F-35 tire for service with tire weighing more than 160 pounds fully assembled. The nose landing gear must be aligned with at least with every tire change and in between after harsh landings.

These frequent nose landing gear alignments are critical for the aircraft. Particularly, the nose landing gear must be azimuthally aligned parallel to the longitudinal axis of the aircraft. Even slight misalignment can lead to mishandling, aircraft damage and even jeopardize pilot safety.

The nose landing gear alignment is determined by a rotatable collar. The collar has a notch which faces forward coincident the longitudinal axis. Currently the collar is aligned with a two leg tow bar. The two legs extend from respective proximal ends at a common hinge point to distal ends remote therefrom. The distal ends are disposed proximate the collar on the landing gear and the entire tow bar used to adjust the azimuthal angle. But despite years of use and refinement, problems remain. The tow bar is almost 12 feet long and weighs 100 pounds. The tow bar is difficult to use because of the size and weight, making accurate alignment of the nose landing gear more difficult to accomplish.

Furthermore, alignment requires at least a two person crew. One person of the crew is at the landing gear and visually determines the desired azimuthal angle. That person relays instructions to the remote person who manipulates the heavy tow bar back and forth as qualitatively instructed by the first crew member. But this method can lead to problems as the visual determination may be subject to parallax error and other errors.

Furthermore, due to the size and weight of the tow bar it must be hauled on a tug to various locations on the tarmac. The tug and a qualified operator may not be available, delaying necessary maintenance for aircraft at distant locations.

Accordingly, a new approach is needed which overcomes the size, weight and accuracy problems which have been present across two decades, three platforms, nine countries, 1500 companies and 250000 employees. The present invention addresses the longstanding problems and provides improved accuracy of the critical nose landing gear alignment.

### SUMMARY OF THE INVENTION

In one embodiment the invention comprises a tool for aligning a nose landing gear of a F-35 aircraft. The tool has a longitudinal axis and comprises a generally planar yoke having two opposed arms extending outwardly from a common yoke proximal end to two yoke distal ends remote therefrom and defining a transverse space therebetween, an extender projecting outwardly from an extender proximal end joined to the generally planar yoke to an extender distal end remote therefrom and a key juxtaposed with the extender distal end and being complementary a notch of the F-35 aircraft landing gear, the key being insertable into the notch to effect azimuthal alignment of the landing gear and retractable from the notch.

In one embodiment the invention comprises a tool for aligning a nose landing gear of a F-35 aircraft. The tool has a longitudinal axis and comprises a generally planar yoke having two opposed arms extending outwardly from a common yoke proximal end to two yoke distal ends remote therefrom and defining a transverse space therebetween, an articulable extender projecting outwardly from an extender proximal end joined to the generally planar yoke to an extender distal end remote therefrom and a key juxtaposed with the extender distal end and being complementary a notch of the F-35 aircraft landing gear, upon forward articulation the key being insertable into the notch to effect azimuthal alignment of the landing gear and being retractable from the notch.

In one embodiment the invention comprises a tool for aligning a nose landing gear of a F-35 aircraft. The tool has a longitudinal axis and comprises a generally planar yoke having two opposed arms extending outwardly from a common yoke proximal end to two yoke distal ends remote therefrom thereby defining a transverse space therebetween, an extender projecting outwardly from an extender proximal end joined to the generally planar yoke to an extender distal end remote therefrom and a key juxtaposed with the extender distal end and being complementary a notch of the F-35 aircraft landing gear, upon vertical translation the key being insertable into the notch to effect azimuthal alignment of the landing gear and being vertically retractable from the notch.

### BRIEF DESCRIPTION OF THE DRAWINGS

FIG. 1 is a schematic top plan view of an aircraft showing the azimuth of the nose landing gear.

FIG. 2A is a schematic fragmentary perspective view of a collar of an aircraft having the gudgeons omitted for clarity and an articulating key.

FIG. 2B is a schematic top plan view of the collar and articulating key of FIG. 2A showing the gudgeons.

FIG. 3 is a scale perspective view of a tow bar according to the prior art with a schematic top plane view of an aircraft.

FIG. 4A is a scale perspective of one embodiment of the present invention.

FIG. 4B is a scale side elevational view of the embodiment of FIG. 4A with an optional schematic cart.

FIG. 4C is a scale rear elevational view of the embodiment of FIG. 4A.

FIG. 4D1 is a single spring scale top plan view of the embodiment of FIG. 4A.

FIG. 4D2 is a dual spring scale top plan view of the embodiment of FIG. 4A.

FIG. 5A is a scale perspective of a second embodiment of the present invention.

FIG. 5B is a scale side elevational view of the embodiment of FIG. 5A.

FIG. 5C is a scale rear elevational view of the embodiment of FIG. 5A.

FIG. 5D is a scale top plan view of the embodiment of FIG. 5A.

FIG. 6A1 is a scale perspective of a second embodiment of the present invention.

FIG. 6A2 is a scale perspective of FIG. 6A1, shown in phantom.

FIG. 6B1 is a scale side elevational view of the embodiment of FIG. 6A1.

FIG. 6B2 is a scale side elevational view of FIG. 6B1, shown in in phantom from the opposite side with a fragmentary schematic landing gear.

FIG. 6C1 is a scale rear elevational view of the embodiment of FIG. 6A1.

FIG. 6C2 is a scale rear elevational view FIG. 6C1, shown in phantom.

FIG. 6C3 is a fragmentary scale rear elevational view of a plural spring embodiment.

FIG. 6D1 is a scale top plan view of the embodiment of FIG. 6A1.

FIG. 6D2 is a scale top plan view of FIG. 6D1, shown in phantom with schematic trunnions.

### DETAILED DESCRIPTION OF THE INVENTION

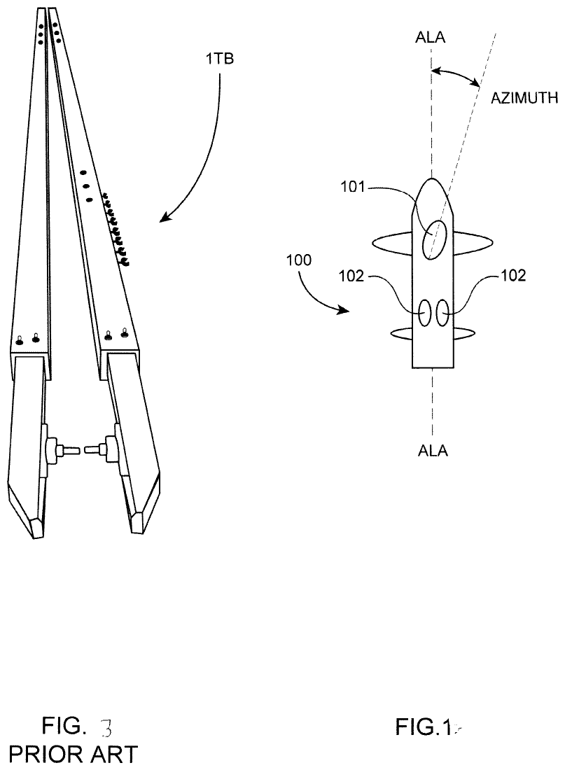

Referring to FIG. 1, aircraft 100 have an aircraft longitudinal axis ALA. Many aircraft 100 according to the current art, such as an F-35 have a single forward nose landing gear 101 and dual aft landing gears 102. Each landing gear 101, 102 is supported by an associated tire. The landing gears 101, 102 must support the tire in an alignment parallel to the aircraft longitudinal axis ALA. Furthermore, the tire of the nose landing gear 101 must be coincident and parallel to the aircraft longitudinal axis ALA. While the discussion below is directed to an F-35 aircraft 100, one of skill will recognize the present invention may be resized and used with any similarly appointed aircraft 100.

A discrepancy between the aircraft longitudinal axis ALA and the angle of the nose landing gear 101 tire is referred to herein as an azimuth. The azimuth is taken in the horizontal plane. The azimuth may be qualitatively determined or quantitatively determined, as designated by hash marks on the face of the yoke 11. Each hash mark may indicate one degree or other angular measurement as desired. When the azimuth is zero, the angle of the nose tire is properly parallel to and coincident the aircraft longitudinal axis ALA

Referring to FIGS. 2A and 2B, the nose landing gear 101 has a collar 31. The collar 31 has a forward notch 32 and two opposed collar gudgeons 33 perpendicular thereto. The forward notch 32 is aligned with the longitudinal axis ALA of the aircraft 100 when properly fixed in azimuthal orientation. The notch 32 is the benchmark for determining azimuthal alignment of the landing gear 101 relative to the aircraft longitudinal axis ALA. The arrow shows the forward direction of the aircraft 100 and aircraft longitudinal axis ALA. A transverse axis TA is orthogonal to the aircraft longitudinal axis ALA and intercepts both collar gudgeons 33.

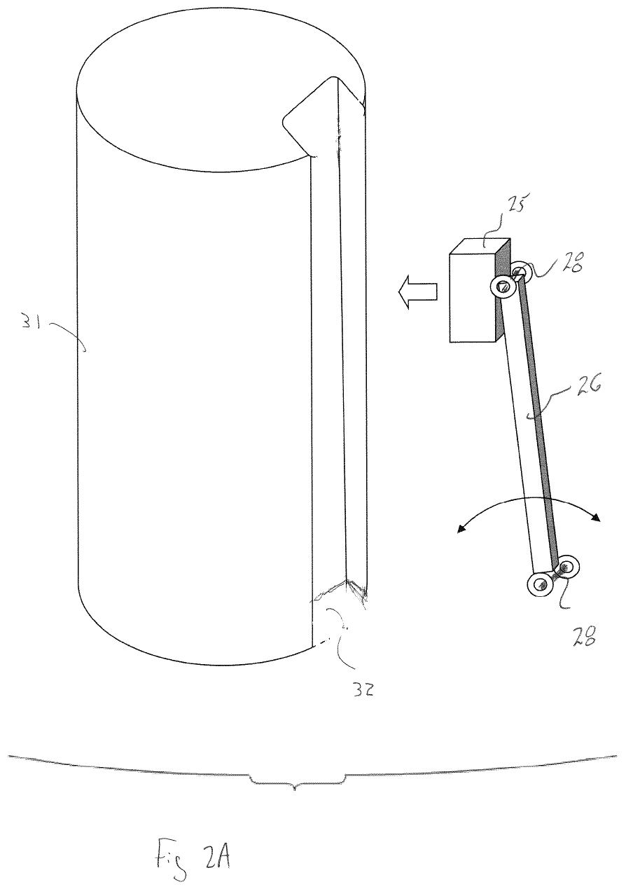

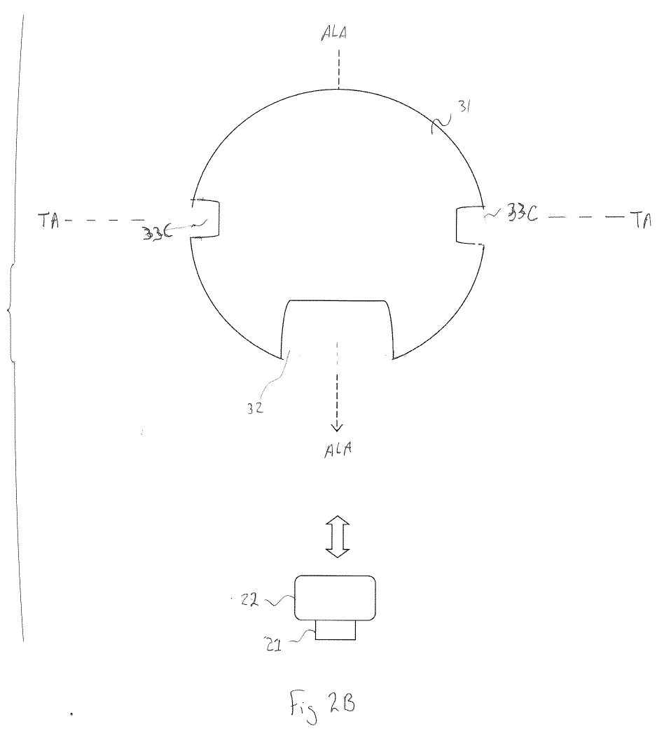

Referring to FIG. 3, according to the prior art a tow bar 1TB is used to maneuver the aircraft 100 from one location to another on the tarmac. The tow bar 1TB is also used to align the nose landing gear 101 in order to zero the azimuth.

The tow bar 1TB is approximately 12 feet in length and weighs approximately 100 pounds. Relocating the tow bar 1TB according to the prior art between aircraft 100 is laborious. The tow bar 1TB must be loaded onto a tug, a qualified tug operator located and the tow bar 1TB delivered to the particular aircraft 100 where needed. After maintenance on that aircraft 100, the process must be repeated for the next aircraft 100.

Furthermore, using the tow bar 1TB to align the nose landing gear 101 is also laborious. The nose landing gear 101 must be accurately aligned, to a very precise azimuthal angle. But the tow bar 1TB is heavy, making accurate alignments difficult to achieve and tiresome for the people doing the alignment.

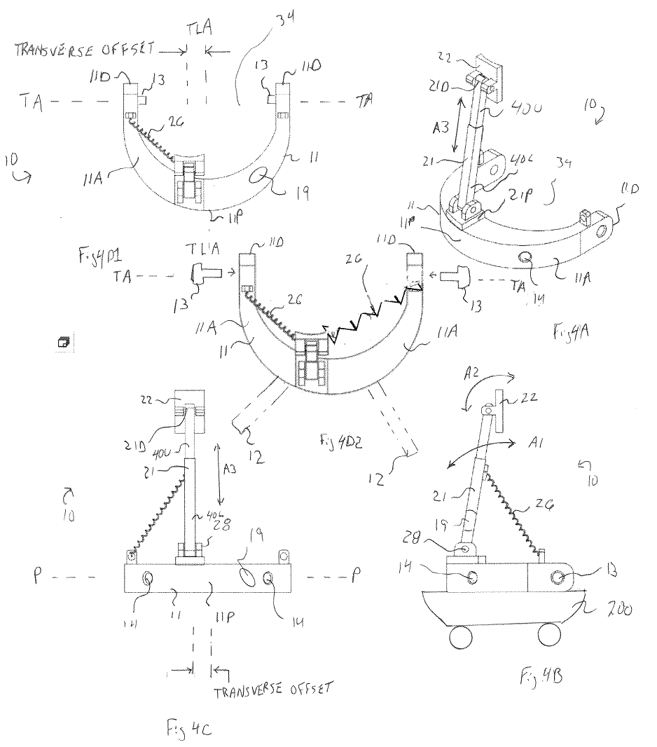

Referring to FIGS. 4A-4D 2, a tool 10 according to the present invention has a yoke 11 which serves as a chassis. The yoke 11 has two opposed arms 11A. The two opposed arms 11A extend outwardly from a common proximal end 11P disposed on a tool longitudinal axis TLA to mutually opposed distal ends 11D spaced transversely outwardly of a tool longitudinal axis TLA. The yoke 11 may be open, symmetric about the tool longitudinal axis TLA, generally planar relative to plane P-P and may be disposed in a generally horizontal position during use. As used herein forward refers to the direction parallel to the longitudinal axis TLA from the proximal end 11P towards the distal ends 11D. Upwards refers to the up direction when a planar yoke 11 is generally horizontal and is perpendicular to the longitudinal axis TLA.

In use there may be a space 34, particularly a semi-annular space 34 between the arms 11A of the yoke 11 to intercept the landing gear 101. The yoke arms 11A may taper from the proximal end 11P to the respective distal ends 11D. This arrangement conserves weight and material where less stress occurs as the distal ends 11D are approached.

Each arm 11A of the yoke 11 may have an optional trunnion 13 juxtaposed with a respective distal end 11D of that arm. The trunnions 13 extend inwardly towards the longitudinal axis TLA. The opposed trunnions 13 are sized and spaced to fit into the gudgeons 33 of the collar 31. The trunnions 13 may be generally cylindrically shaped with a round cross section. The trunnions 13 may be inserted from outside the yoke 11 towards the longitudinal axis TLA. The trunnions 13 may have a shank 13S which intercepts the gudgeon 33 of the landing gear 101. A transverse axis TA connects the centers of the gudgeons 33. The transverse axis TA is perpendicular to the longitudinal axis TLA and lies in the same plane. The trunnions 13 apply torque to the landing gear 101 and tire to adjust, minimize and eliminate the azimuth.

One or more optional breaker bars 12 may be removably or fixedly joined to the yoke 11 and particularly at the common proximal end 11P of the yoke 11 arms 11A. An optional breaker bar 12 may be coincident the longitudinal axis TLA and function as a handle for manipulation of the tool 10 by a user. Preferably two breaker bars 12 are used, and circumferentially spaced apart, so that two people may manipulate the tool 10 at the same time. If desired, the breaker bars 12 may be threadably or frictionally attached to the yoke 11 at complementary holes 14. This arrangement provides for disassembly during storage and reassembly for use.

The tool 10 has a key 22 which is removably insertable into the notch 32. The key 22 is fixedly or pivotally mounted on an articulable extender 21. The key 22 is manually inserted into the notch 32 when the user azimuthally aligns the nose landing gear. The key 22 is also manually removed from the notch 32 when maintenance is complete. The tool 10 may then be stored or deployed to the next aircraft 100.

The extender 21 has a proximal end 21P articulably joined to the yoke 11 and a distal end 21D remote therefrom. The key 22 is juxtaposed with the distal end 21D of the extender 21. The key 22 is complementary to and fits within the notch 32 for azimuthal alignment. By complementary it is meant that the key 22 is insertable into the notch 32. And while inserted into the notch 32 the key 22 can bear against either side of the notch 32 to effect azimuthal adjustment and alignment parallel to the aircraft longitudinal axis ALA during and throughout insertion. And furthermore, the complementary key 22 is removable from the notch 32 by retraction of the extender 21 or retraction of the key 22 relative to the extender 21. The complementary key 22 has a forward face which preferably seats against the notch 32 to ensure proper and full engagement. The key 22 may be padded to prevent damage to the notch 32 or other parts of the nose landing gear 101. Azimuthal alignment of the landing gear may be effected while the key 22 is inserted into the notch 32 by manually rotating the yoke 11 about a vertical axis in the yoke space 34.

The extender 21 articulates towards the notch 32 for azimuthal alignment of the nose landing gear and retracts for storage and maintenance as shown by Arrow A1. The key 22 pivots about a pivot 28 coincident the horizontal axis to ensure the key 22 is fully engaged when in the forward position as shown by Arrow A2. The extender 21 may be lengthened and shortened between the proximal end 21P and distal end 21D, in the direction of Arrow A3. Lengthening and shortening the extender 21 allows for accurate placement of the key 22 into the notch 32 when various carts 200 and maintenance personnel are used.

The extender 21 may comprise a lower sleeve 40L joined to the yoke 11 at a pivot 28 and an upper sleeve 40U. The upper sleeve 40U and lower sleeve 40L may telescope to provide for the desired length of the extender 21 between the extender proximal end 21P and the extender distal end 21D. That is telescoping of the upper sleeve 40U and lower sleeve 40L can lengthen or shorten the effective length of the extender 21. Lengthening and shortening the extender 21 increases and decreases, respectively, the radii of the arcs subtended by the key 22. This arrangement provides the benefit of flexibility to accommodate tarmacs, etc. which are not flat or level. While two sleeves 40U, 40L are shown, one of skill will recognize that additional sleeves may be used as needed.

The tool 10 may further comprise an optional return spring 26. The return spring 26 urges the extender 21 and key 22 forward. This arrangement provides for engagement of the key 22 with the notch 32 while personnel ensure proper registration and alignment. The return spring 26 is joined to the extender 21 at a first end and to the yoke 11 at a second end. The spring 26 may be tensioned throughout the arc of the extender 21 travel to minimize damage from unrestrained movement of the extender 21 and key 22. If desired, two return springs 26 may be utilized to offset transverse forces.

The extender 21 can articulate forward of the cart to horizontally engage the notch 32. This embodiment provides the benefits of a single-piece extender 21 and that the personnel can easily see the engagement of the horizontally extendable key 22 from various positions near the nose landing gear 101.

In each of the embodiments described herein, the yoke 11 and extender 21 may be permanently joined together for strength and to prevent lost parts. Alternatively, the key 22 and extender 21 may be removably joined to provide for compact storage. All embodiments described herein may have indica disposed on the tool 10. The indicia 19 may provide instructions for use, safety warnings, inventory control, etc. While a generally planar yoke 11 is shown, one of skill will recognize the invention is not so limited. A nonplanar yoke 11 may be used, provided that the yoke 11 is substantially symmetrical about the longitudinal axis TLA of the yoke 11. The tool 10 may be disposed on an optional wheeled cart 200 for convenient transport to and from the aircraft 100 under consideration.

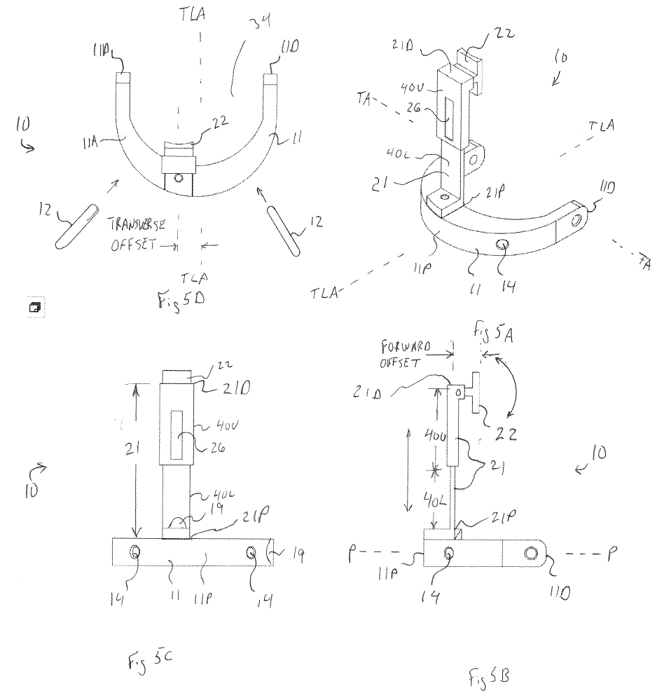

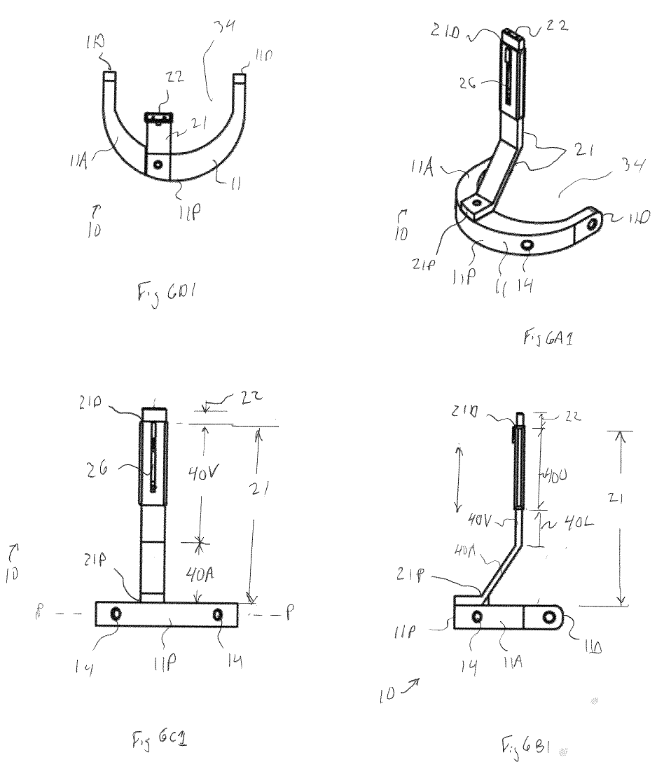

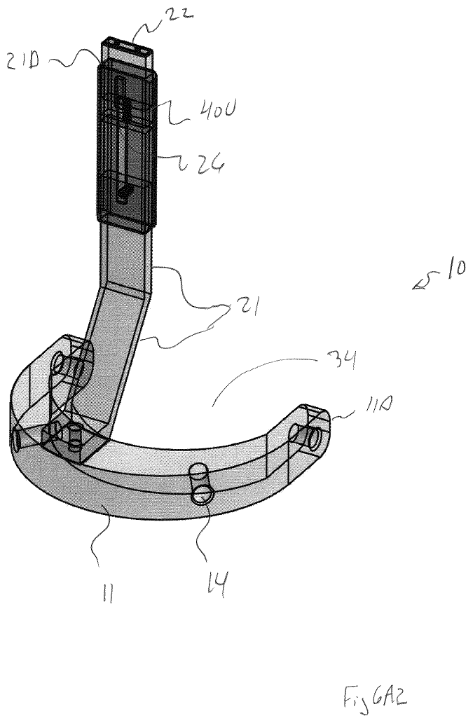

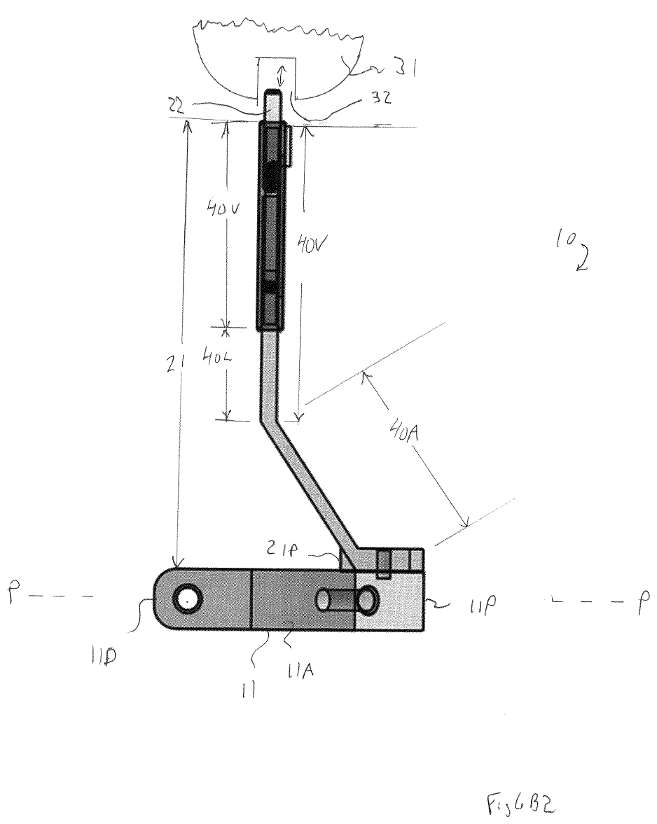

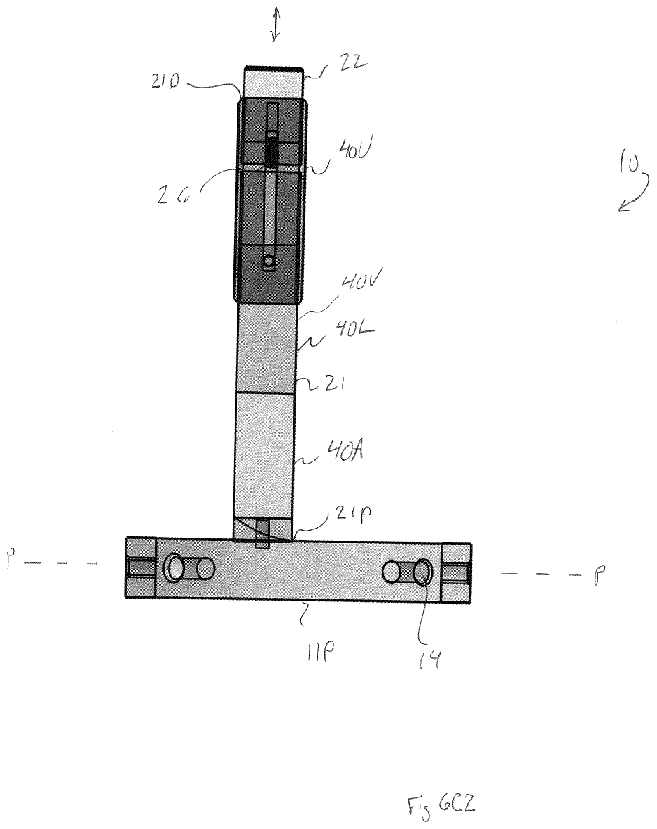

Referring to FIGS. 5A-5D, in another embodiment the tool 10 may have an inarticulable extender 21. This extender 21 is identically or substantially vertically extendable. In a preferred embodiment the extender 21 and yoke 11 are mutually perpendicular so that the extender 21 is identically vertical when the yoke 11 is horizontal. This arrangement provides the best ergonomics for viewing the yoke 11 during use of the tool 10 and maximizes useful travel of the key 22. As described above, the key 22 is fixedly or pivotally attached to the extender 21.

The extender 21 has two or more telescoping sleeves 40U, 40L, comprising at least an upper sleeve 40U and a lower sleeve 40L. Preferably the lower sleeve 40L telescopes into the upper sleeve 40U, to provide a shroud in the rain. The sleeves 40U, 40L may have a compression spring 26 therebetween to urge the upper sleeve 40U towards the notch 32, providing the benefit of avoiding manual lifting of the key 22 and freeing the hands of the user. Alternatively, the spring 26 may urge the upper sleeve 40U vertically downward, towards the lower sleeve 40L. This arrangement provides the benefit that with the key 22 retracted, unintended impact of the key 22 with the nose landing gear 101 is avoided, eliminating damage to the tool 10 and aircraft 100. If a spring 26 is not used, the extender 21 may be held in position with a vertically spaced holes and a quick release pin.

The key 22 is preferably longitudinally forwardly spaced from the yoke 11 by a forward offset, as shown. This geometry accommodates the geometry of the aircraft 100. The key 22 is also preferably transversely offset from the aircraft longitudinal axis ALA as described above. The transverse offset accounts for the offset of the tire from the landing gear.

The extender 21 is elongated in the vertically upward direction to engage the key 22 with the notch 32. While the key 22 is engaged with the notch 32, the nose landing gear 101 is azimuthally aligned as needed. After alignment is completed, the tool 10 may be retracted away from the aircraft 100 in the forward direction. Or the extender 21 may be vertically retracted so that the key 22 is clear and the tool 10 removed for storage or further use. This embodiment provides the benefit that the tool 10 may be disposed underneath the notch 32, conserving space in front of the aircraft 100 for personnel and other equipment.

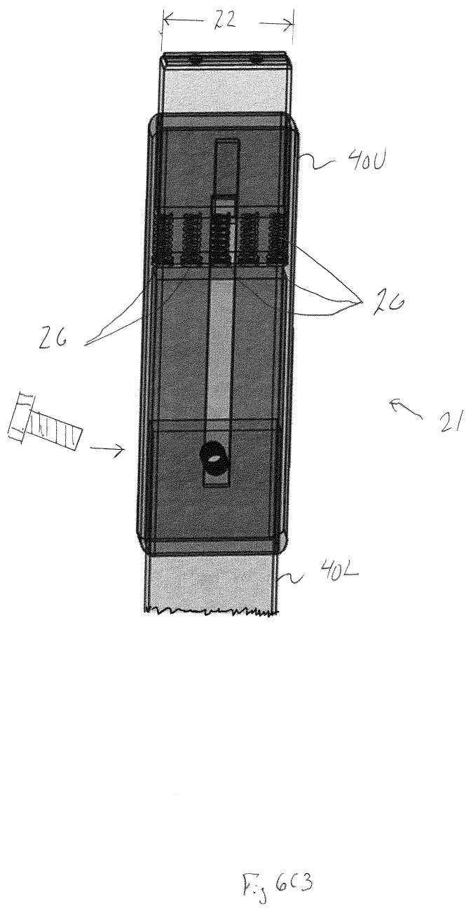

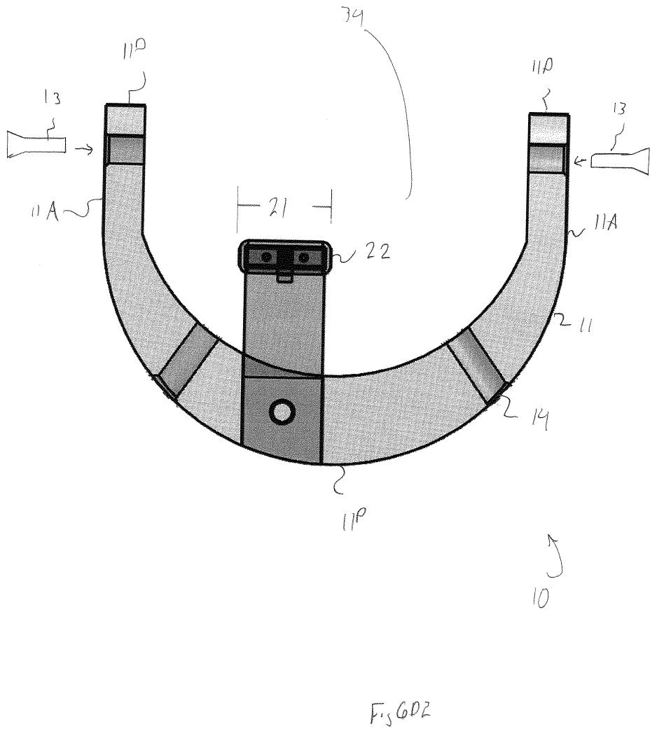

Referring to FIG. 6A1-6D2, in yet another embodiment the tool 10 may have a two-leg extender 21. Such an extender 21 has an angled leg 40A joined at a proximal end 21P to the yoke 11. The angled leg 40A extends forwardly and upwardly to a distal end. A vertical leg 40V is joined to the distal end of the angled leg 40A and extends substantially upwardly, preferably vertically, therefrom. The angled leg 40A forms an angle of 45 to 55 degrees and preferably 45 degrees relative to the yoke 11. The key 22 is movably, preferably translatably, disposed on the vertical leg 40V.

The extender 21 has a stationary lower sleeve 40L. The lower sleeve 40L has an angled leg 40A fixedly joined to the yoke 11 and a vertical leg 40V extending upwards from the angled leg 40A. The upper sleeve 40U is stationary and may be telescoped over the lower sleeve 40L. The key 22 vertically translates within the upper sleeve 40U. The key 22 may be temporarily fixed in the vertically extended, upwards position by a quick release pin or bolt.

One or more springs 26 may be disposed within the upper sleeve 40U of the extender 21. The one or more springs 26 are preferably compression springs 26 to urge the key 22 upwards and into the notch 32, as described above. This embodiment provides the benefit that the angled leg 40A of the extender 21 can clear the frame of the aircraft 100 during azimuthal alignment, providing improved ergonomics.

All values disclosed herein are not strictly limited to the exact numerical values recited. Unless otherwise specified, each such dimension is intended to mean both the recited value and a functionally equivalent range surrounding that value. For example, a dimension disclosed as “40 mm” is intended to mean “about 40 mm.” The term “or” as used herein is to be interpreted as an inclusive or meaning any one or any combination. Therefore, “A, B or C” means “any of the following: A; B; C; A and B; A and C; B and C; A, B and C.” Every document cited herein, including any cross referenced or related patent or application, is hereby incorporated herein by reference in its entirety unless expressly excluded or otherwise limited. The citation of any document or commercially available component is not an admission that such document or component is prior art with respect to any invention disclosed or claimed herein or that alone, or in any combination with any other document or component, teaches, suggests or discloses any such invention. Further, to the extent that any meaning or definition of a term in this document conflicts with any meaning or definition of the same term in a document incorporated by reference, the meaning or definition assigned to that term in this document shall govern according to Phillips v. AWH Corp., 415 F.3d 1303 (Fed. Cir. 2005). All limits shown herein as defining a range may be used with any other limit defining a range of that same parameter. That is the upper limit of one range may be used with the lower limit of another range for the same parameter, and vice versa. As used herein, when two components are joined or connected the components may be interchangeably contiguously joined together or connected with an intervening element therebetween. A component joined to the distal end of another component may be juxtaposed with or joined at the distal end thereof. While particular embodiments of the present invention have been illustrated and described, it would be obvious to those skilled in the art that various other changes and modifications can be made without departing from the spirit and scope of the invention and that various embodiments described herein may be used in any combination or combinations. It is therefore intended the appended claims cover all such changes and modifications that are within the scope of this invention.

1. A tool for aligning a nose landing gear of a F-35 aircraft, the tool defining a longitudinal axis and comprising:
a generally planar yoke having two opposed arms extending outwardly from a common yoke proximal end to two yoke distal ends remote therefrom and defining a transverse space therebetween;
an extender projecting outwardly from an extender proximal end joined to the generally planar yoke to an extender distal end remote therefrom; and
a key juxtaposed with the extender distal end and being complementary a notch of the F-35 aircraft landing gear, the key being insertable into the notch to effect azimuthal alignment of the landing gear and retractable from the notch.

2. A tool for aligning a nose landing gear of a F-35 aircraft, the tool defining a longitudinal axis and comprising:
a generally planar yoke having two opposed arms extending outwardly from a common yoke proximal end to two yoke distal ends remote therefrom and defining a transverse space therebetween;
an articulable extender projecting outwardly from an extender proximal end joined to the generally planar yoke to an extender distal end remote therefrom; and
a key juxtaposed with the extender distal end and being complementary a notch of the F-35 aircraft landing gear, upon forward articulation the key being insertable into the notch to effect azimuthal alignment of the landing gear and being retractable from the notch.

3. A tool for aligning a nose landing gear of a F-35 aircraft, the tool defining a longitudinal axis and comprising:
a generally planar yoke having two opposed arms extending outwardly from a common yoke proximal end to two yoke distal ends remote therefrom and defining a transverse space therebetween;
an extender projecting outwardly from an extender proximal end joined to the generally planar yoke to an extender distal end remote therefrom; and
a key juxtaposed with the extender distal end and being complementary a notch of the F-35 aircraft landing gear, upon vertical translation the key being insertable into the notch to effect azimuthal alignment of the landing gear and being vertically retractable from the notch.

4. A tool according to claim 2 wherein the key is pivotally attached to the extender.

5. A tool according to claim 4 wherein the extender comprises two telescoping sleeves configured to lengthen or shorten the length of the extender.

6. A tool according to claim 5 further comprising a return spring configured to urge the extender towards a forward position for engagement with the notch.

7. A tool according to claim 2 further comprising two trunnions extending inwardly towards the longitudinal centerline, one trunnion juxtaposed with each yoke distal end, wherein the two trunnions are configured to fit into two opposed gudgeons of the landing gear.

8. A tool according to claim 3 wherein the extender and the yoke are mutually perpendicular.

9. A tool according to claim 3 wherein the key is fixedly mounted to the extender.

10. A tool according to claim 3 wherein the wherein the extender comprises two telescoping sleeves configured to lengthen or shorten the length of the extender.

11. A tool according to claim 10 wherein the two sleeves comprise and upper sleeve and a lower sleeve subjacent thereto, and the lower sleeve telescopes into the upper sleeve.

12. A tool according to claim 10 further comprising a spring operably associated with the key and configured to urge the key towards an extended position.

13. A tool according to claim 3 wherein the extender comprises an angled leg joined to the yoke and extending upwardly and forwardly therefrom and a vertical leg joined to the angled leg and extending upwardly therefrom.

14. A tool according to claim 13 wherein the key is operably disposed on the vertical leg.

15. A tool according to claim 14 wherein the key is translatably disposed in an upper sleeve telescoped over the vertical leg.

16. A tool according to claim 15 further comprising a compression spring disposed within the upper sleeve and urging the key upwardly.

17. A tool according to claim 1 wherein the key is bilaterally insertable and retractable on a curvilinear path.

18. A tool according to claim 17 configured for the key to subtend curvilinear paths having different radii.

19. A tool according to claim 1 wherein the yoke is generally planar.

20. A tool according to claim 19 wherein the key translates in a direction generally perpendicular to the yoke.
